(19) United States
(12) Patent Application Publication
(10) Pub. No.: US 2013/0029842 A1
(43) Pub. Date: Jan. 31, 2013

(54) CORE-SHELL TYPE METAL NANOPARTICLES AND METHOD FOR PRODUCING THE SAME

(71) Applicants: Hiroko Kimura, Susono-shi (JP); Naoki Takehiro, Suntou-gun (JP); Koshi Sekizawa, Susono-shi (JP); Atsuo Iio, Susono-shi (JP); Tatsuya Arai, Susono-shi (JP)

(72) Inventors: Hiroko Kimura, Susono-shi (JP); Naoki Takehiro, Suntou-gun (JP); Koshi Sekizawa, Susono-shi (JP); Atsuo Iio, Susono-shi (JP); Tatsuya Arai, Susono-shi (JP)

(73) Assignee: TOYOTA JIDOSHA KABUSHIKI KAISHA, Toyota-shi, Aichi (JP)

(21) Appl. No.: 13/581,732

(22) PCT Filed: Apr. 7, 2010
(86) PCT No.: PCT/JP2010/056342

§ 371 Date: Aug. 29, 2012

(51) Int. Cl. B01J 23/44; B01J 23/46; B01J 23/42; B01J 35/02; B01J 23/52; B82Y 40/00; B82Y 30/00

(52) U.S. Cl. 502/339; 502/300; 502/325; 502/344; 977/777; 977/890

(57) ABSTRACT

The present invention provides core-shell type metal nanoparticles having a high surface coverage of the core portion with the shell portion, and a method for producing the same. Disclosed is core-shell type metal nanoparticles comprising a core portion comprising a core metal material and a shell portion covering the core portion, wherein the core portion substantially has no {100 } plane of the core metal material on the surface thereof.

### TECHNICAL FIELD

The present invention relates to core-shell type metal nanoparticles having a high surface coverage of the core portion with the shell portion, and a method for producing the same.

### BACKGROUND ART

A fuel cell converts chemical energy directly to electrical energy by supplying a fuel and an oxidant to two electrically-connected electrodes and causing electrochemical oxidation of the fuel. Unlike thermal power generation, fuel cells are not limited by Carnot cycle, so that they can show high energy conversion efficiency. In general, a fuel cell is formed by stacking a plurality of single fuel cells each of which has a membrane electrode assembly as a fundamental structure, in which an electrolyte membrane is sandwiched between a pair of electrodes.

Platinum or platinum alloys have been used as an electrode catalyst for fuel cells. However, especially in the case of using platinum alloys, since metals present on the alloy surface other than platinum are eluted, there is a problem of a decrease in battery voltage during long-time operation of a fuel cell.

As a technique for preventing such catalyst metal elution, Patent Literature 1 discloses an electrode catalyst in which a noble metal alloy comprising a noble metal and a transition metal is supported on a carrier and which is an electrode catalyst characterized by that the surface of the noble metal alloy is covered with a noble metal film.

### CITATION LIST

Patent Literature 1: Japanese Patent Application Laid-Open No. 2006-205088

### SUMMARY OF INVENTION

### Technical Problem

The electrode catalyst disclosed in Patent Literature 1 is not such that the whole surface of a noble metal alloy is completely covered with a noble metal film, as shown in FIG. 1 of the literature. Also, as disclosed in Table 1 of Examples, in the electrode catalyst disclosed in the literature, the composition ratio of a transition metal of the surface of catalyst particles is not 0; therefore, it is clear that the cores of the catalyst particles containing the transition metal, are exposed on the surface of the catalyst particles.

The present invention was achieved in view of the above circumstances. An object of the present invention is to provide core-shell type metal nanoparticles having a high surface coverage of the core portion with the shell portion, and a method for producing the same.

### Solution to Problem

The core-shell type metal nanoparticles of the present invention comprise a core portion comprising a core metal material and a shell portion covering the core portion, wherein the core portion substantially has no {100} plane of the core metal material on the surface thereof.

In the core-shell type metal nanoparticles having such a structure, the surface of the core portion substantially has no crystal plane having a low surface coverage with the shell portion; therefore, the coverage of the core portion with the shell portion relative to the total surface area of the core portion, is kept higher than that of core-shell type fine particles having such a crystal plane on the surface of the core portion thereof, and it is thus possible to prevent elution of the core portion.

An embodiment of the core-shell type metal nanoparticles of the present invention is that the core portion comprises a metal crystal having a crystal system that is a cubic system and a lattice constant of a=3.60 to 4.08 Å.

An embodiment of the core-shell type metal nanoparticles of the present invention is that the shell portion comprises a metal crystal having a crystal system that is a cubic system and a lattice constant of a=3.80 to 4.08 Å.

In the core-shell type metal nanoparticles of the present invention, the surface coverage of the core portion with the shell portion is preferably 0.9 to 1.

The core-shell type metal nanoparticles having such a structure can prevent elution of the core portion further.

In the core-shell type metal nanoparticles of the present invention, the core metal material is preferably a metal material selected from the group consisting of palladium, copper, nickel, rhodium, silver, gold, iridium and alloys thereof.

In the core-shell type metal nanoparticles of the present invention, the shell portion preferably comprises a metal material selected from the group consisting of platinum, iridium, gold and alloys thereof.

An embodiment of the core-shell type metal nanoparticles of the present invention is that the nanoparticles are supported by a carrier.

The method for producing the core-shell type metal nanoparticles of the present invention is a method for producing core-shell type metal nanoparticles comprising a core portion comprising a core metal material and a shell portion covering the core portion, the method at least comprising the steps of: preparing fine core particles comprising the core metal material and substantially having no {100} plane of the core metal material on the surface thereof, and covering each of the fine core particles, which is the core portion, with the shell portion.

As the fine core particles, the production method of such a structure uses fine particles substantially having no crystal plane having a low surface coverage of the core portion with the shell portion; therefore, compared with the case of using fine particles having the crystal plane on the surface thereof as the core portion, it is possible to produce core-shell type metal nanoparticles having a high surface coverage of the core portion with the shell portion.

An embodiment of the method for producing core-shell type metal nanoparticles of the present invention is that the core portion covering step with the shell portion comprises at least the steps of: covering each of the fine core particles, which is the core portion, with a monatomic layer, and replacing the monatomic layer with the shell portion.

An embodiment of the method for producing core-shell type metal nanoparticles of the present invention is that a metal crystal having a crystal system that is a cubic system and a lattice constant of a=3.60 to 4.08 Å, is used as the fine core particles.

An embodiment of the method for producing core-shell type metal nanoparticles of the present invention is that a metal crystal having a crystal system that is a cubic system and a lattice constant of a=3.80 to 4.08 Å is used in the shell portion.

In the method for producing core-shell type metal nanoparticles of the present invention, the core metal material is preferably a metal material selected from the group consisting of palladium, copper, nickel, rhodium, silver, gold, iridium and alloys thereof.

In the method for producing core-shell type metal nanoparticles of the present invention, the shell portion preferably comprises a metal material selected from the group consisting of platinum, iridium, gold and alloys thereof.

An embodiment of the method for producing core-shell type metal nanoparticles of the present invention is that the fine core particles are supported by a carrier.

### Advantageous Effects of Invention

According to the present invention, the surface of the core portion substantially has no crystal plane having a low surface coverage with the shell portion; therefore, the coverage of the core portion with the shell portion relative to the the total surface area of the core portion, is kept higher than that of core-shell type fine particles having such a crystal plane on the surface of the core portion thereof, and it is thus possible to prevent elution of the core portion.

### BRIEF DESCRIPTION OF DRAWINGS

FIG. 1 shows a voltammogram of the palladium-supporting carbon of Example in a perchloric acid aqueous solution.

FIG. 2 shows a voltammogram of the palladium-supporting carbon of Example in a mixed aqueous solution of CuSO₄ and H₂SO₄.

FIG. 3 shows a voltammogram of the palladium-supporting carbon of Comparative Example in a perchloric acid aqueous solution.

FIG. 4 shows a voltammogram of the palladium-supporting carbon of Comparative Example in a mixed aqueous solution of CuSO₄ and H₂SO₄.

FIG. 5 is a schematic perspective view showing a truncated octahedron-shaped face-centered cubic metal particle.

FIG. 6 is a graph showing a correlation between the particle diameter and surface of palladium fine particles obtained by simulation.

### DESCRIPTION OF EMBODIMENTS

### 1. Core-Shell Type Metal Nanoparticles

The core-shell type metal nanoparticles of the present invention comprise a core portion comprising a core metal material and a shell portion covering the core portion, wherein the core portion substantially has no {100} plane of the core metal material on the surface thereof.

In the present invention, to describe a predetermined crystal plane of the metallic crystal, a combination of the chemical formula (in the case of a simple substance, chemical symbol) and predetermined crystal plane of the crystal is used, the formula showing the chemical composition of the crystal. For example, “Pd{100} plane” refers to the {100} plane of a palladium metallic crystal. In the present invention, equivalent crystal planes are each put in curly braces to describe. For example, (110) plane, (101) plane, (011) plane, (**0) plane, (*0*) plane and (0**) plane (numbers each represented by an asterisk (*) refer to “1 with an overbar”) are all represented by {110} plane.

As described above, metals having high catalyst activity have been employed as the electrode catalyst for fuel cells, such as platinum and the like. However, despite the fact that platinum and the like are very expensive, catalysis takes place only on the surface of a platinum particle, and the inside of the particle rarely participates in catalysis. Therefore, the catalyst activity of the platinum catalyst is not necessarily high, relative its material cost.

To overcome such an issue, the inventors of the present invention have focused attention on core-shell type fine particles comprising a core portion and a shell portion covering the core portion. In the core-shell type fine particles, the inside of each particle, which rarely participates in catalysis, can be formed at a low cost by using a relatively inexpensive material for the core portion. The use of a material having a high catalytic activity for the shell portion is advantageous in that the shell portion shows a higher catalytic activity than the case of using the material in bulk.

However, as with the electrode catalyst disclosed in Patent Literature 1, especially in the field of fuel cells, core-shell type fine metal particles used as a catalyst has a low surface coverage of the core portion with the shell portion. The durability of such conventional core-shell type catalysts is decreased since the core portion is likely to be eluted in electrode reaction. Therefore, in the case of using such core-shell type catalysts, there is a possibility that the life of a fuel cell will be shortened.

The reason for the problem will be explained below, taking core-shell type metal nanoparticles as an example, comprising a single crystal of palladium as the core portion and a platinum monatomic layer as the shell portion. In the present invention, “monatomic layer” is a general term for single atomic layer and layers less than single atomic layer. Herein, “single atomic layer” refers to a one-atom-thick continuous layer, and “layers less than single atomic layer” refer to one-atom-thick discontinuous layers.

An example of the method for covering the low index planes of the single crystal of palladium with a platinum monatomic layer is a method comprising the steps of forming a copper monatomic layer on the low index planes of the single crystal of palladium and then replacing the copper monatomic layer with a platinum monatomic layer.

In the case where the low index planes of the single crystal of palladium is covered with a copper monatomic layer by the Cu-under potential deposition method (hereinafter referred to as “Cu-UPD method”) described below, it is reported that copper coverage of the surface of Pd{100} plane is 0.67 and copper coverage of the surface of Pd{111} plane and that of Pd{110} plane are 1 each (The New Energy and Industrial Technology Development Organization, Progress Report 2007-2008, “Strategic technology development of practical application of polymer electrolyte fuel cell, Next-generation technology development, and Research and development of highly-active, shape controlled surface and metal nanoparticle catalyst,” p. 28).

Therefore, in the case where palladium fine particles having less Pd{111} and Pd{110} planes and many Pd{100} planes on the surface thereof, is used as a core metal material which is a raw material for the core-shell type metal nanoparticles, copper coverage of the core metal material relative to the total surface area of the core metal material, is presumed to be less than 1 after Cu-UPD. Therefore, after replacing the copper monatomic layer with a platinum monatomic layer, platinum coverage of the core metal material relative to the total surface area of the core metal material, is presumed to be automatically less than 1.

As a result, core-shell type metal nanoparticles in which the core portion comprising palladium, which is more likely to be eluted than palladium, is exposed on the surface thereof. In a fuel cell using the core-shell type metal nanoparticles as a fuel cell catalyst, the core portion is likely to be eluted during operation of the fuel cell; therefore, the durability of the catalyst is decreased and thus there is a possibility that the life of the fuel cell is shortened.

As the result of diligent researches, the inventors of the present invention have found that in the core-shell type metal nanoparticles comprising the core portion substantially having no {100} plane of the core metal material on the surface thereof and having a low surface coverage with the shell portion, the coverage of the core portion with the shell portion relative to the total surface area of the core portion, is kept higher than that of core-shell type fine particles having such a crystal plane on the surface of the core portion thereof, and it is thus possible to prevent elution of the core portion. Therefore, the inventors completed the present invention based on the above knowledge.

In the present invention, the state in which “the core portion substantially has no {100} plane of the core metal material on the surface thereof” means a state in which a large part of the surface of the core portion is covered with crystal planes of the core metal material, the planes excluding {100} plane, and no {100} plane is present at all on the surface of the core portion, or a state in which a negligible small area of {100} plane is present on the surface of the core portion.

Hereinafter, there will be described examples of the method for calculating the ratio of the area of a specific crystal plane on the core portion surface to the total surface area of the core portion.

The inventors of the present invention calculated the ratio of the area of a specific crystal plane to the total surface area of a metal crystal by, based on the shape of a metal crystal produced by a conventional technique, simulation of a crystal plane that will appear on the surface of the metal crystal. Hereinafter, there will be explained an example of the simulation of fine palladium particles structure by the embedded atom method (hereinafter referred to as EAM), which is a molecular mechanics method developed for metal atoms.

Hereinafter, the outline of the simulation will be explained.

First, the initial structure of palladium clusters having different numbers of atoms is prepared. To minimize simulation time, structures that are deemed to be close to the desired stable structures, are selected as the initial structure. Details of the initial structure will be explained later.

Next, a stable structure is searched by the Monte Carlo (hereinafter referred to as MC) simulation. In each MC step, the total energy of systems is calculated by the EAM method and then compared to the energy in the last MC step to determine whether the structure in the MC step is employed as the stable structure or not. The Metropolis method can be used as the algorithm for the determination. In the first MC step, the maximum number of displacements, Nₘₐₓ, can be 0.15 Å, and the temperature can be 298 K. The probability in which displacement is allowed in this condition in one step, is about 0.5. This MC step is repeated 1.0×10⁷ times. Of the thus-obtained allowed structures, 400 structures sampled for every 10,000 times in the last 4.0×10⁶ times, are used for evaluation of the property of the stable structure.

Then, the thus-obtained structure is analyzed. The purpose of the analysis is to analyze the ratio of atoms exposed on the surface and the ratio of plane indices exposed on the surface. To do this, it is needed to determine whether a certain type of atoms are exposed on the surface and what the plane index of the surface is where a certain types of atoms are exposed. The coordination number of atoms can be used to determine the condition of such exposed atoms. The coordination number is the number of atoms adjacent to one atom. In the system composed of a face-centered cubic metal such as palladium atom, there is a correspondence relationship as shown in the following Table 1 between plane index and coordination number. In the present invention, for the purpose of simplifying the analysis, it is allowed to differentiate the structure by using coordination number only, assuming that coordination number and plane index have a one to one correspondence relationship.

In the calculation of energy, among several kinds of EAMs, the modified EAM (hereinafter referred to as MEAM) can be used, which is excellent for reproduction of the stability of a crystal plane.

TABLE 1

| | Coordination Number |
|---|---|
| (110) Plane | 7 |
| (100) Plane | 8 |
| (111) Plane | 9 |
| Bulk Atom | 12 |

Hereinafter, details of the simulation will be explained.

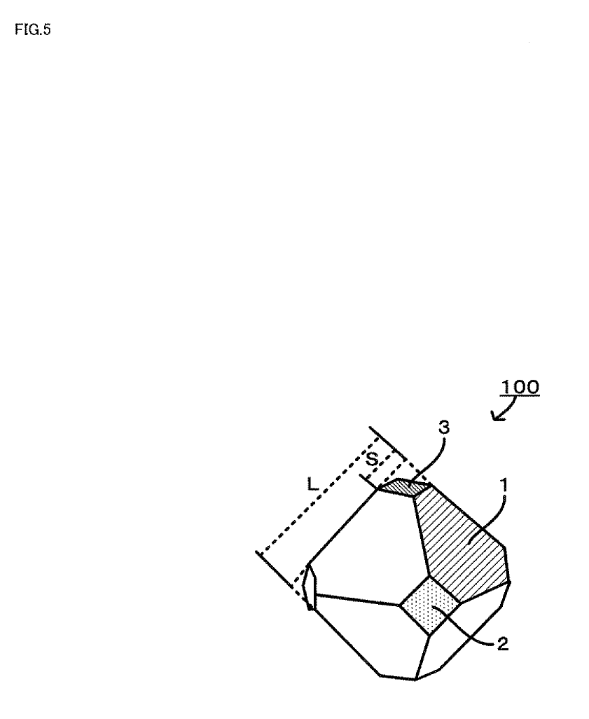

First, consideration of the initial structure is carried out. In the case of face-centered cubic metal particles such as fine palladium particles, they are generally known to be in a truncated octahedron shape as shown in FIG. 5. Truncated octahedron 100 shown in FIG. 5 is surrounded by Pd{111} plane 1, Pd{100} plane 2 and Pd{110} plane 3. In the case of truncated octahedron structure, the structure is defined by the ratio (s/L) of a side of a truncated part, s, to a side of an octahedron, L. To determine the most optimal s/L value, structure stability was evaluated for several kinds of clusters having their s/L values in the range of s/L=0 to 0.4, by a single point energy calculation by EAM. As a result, a structure having s/L=0.2, which is a truncated octahedron structure having the most stable energy per atom, was determined as the initial structure.

For some cluster structures having s/L=0.2, a simulation of the correlation between the particle diameter of fine palladium particles and the surface thereof, was carried out. The following table 2 shows the number of atoms of and the particle diameter of the initial structure used in the simulation.

TABLE 2

| Number of Atoms | Particle Diameter (nm) |
|---|---|
| 79 | 1.27 |
| 201 | 1.79 |
| 459 | 2.53 |
| 807 | 3.04 |
| 1,385 | 3.78 |
| 2,171 | 4.53 |
| 3,101 | 5.02 |
| 4,399 | 5.77 |
| 5,851 | 6.26 |

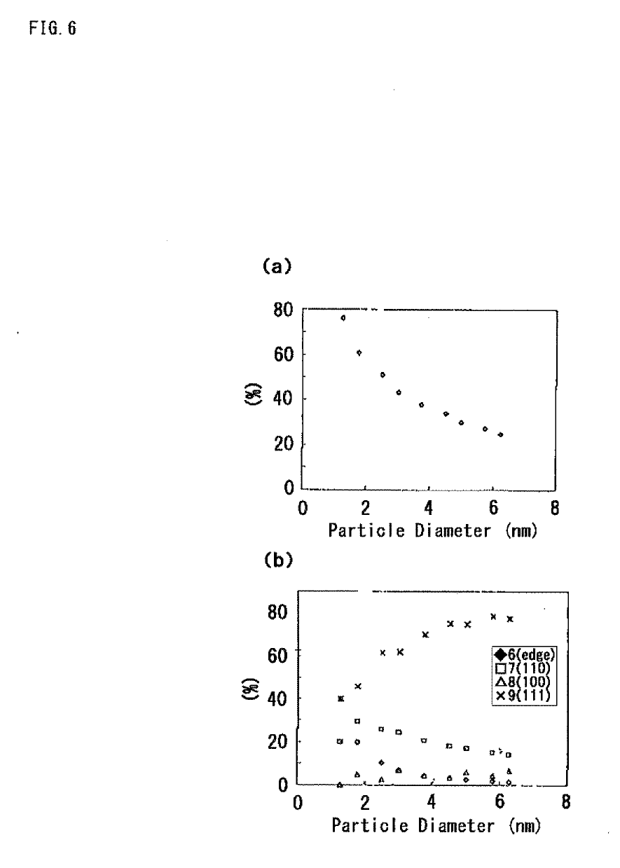

FIG. 6(a) is a graph showing the particle size dependence of the ratio of surface atoms to the total number of atoms, which was obtained by the simulation. FIG. 6(a) is a graph with particle diameter (nm) on the horizontal axis and the ratio (%) of the number of surface atoms to the total number of atoms on the vertical axis. As shown in FIG. 6(a), the smaller the particle diameter, the larger the ratio of particle surface.

FIG. 6(b) is a graph showing the particle size dependence of the ratio of the crystal planes among surface atoms. FIG. 6(b) is a graph with particle diameter (nm) on the horizontal axis and the ratio (%) of the number of atoms to the number of surface atoms on the vertical axis. In the graph, black lozenge indicates a value relative to an edge site having a coordination number of 6; white square indicates a value relative to Pc:1{110} plane having a coordination number of 7; white triangle indicates a value relative to Pd{100} plane having a coordination number of 8; and X indicates a value relative to Pd{111} plane having a coordination number of 9. When the particle diameter is as relatively large as 4 to 6 nm, Pd{111} plane having a coordination number of 9 is the widest. This is because Pd{111} plane is the most stable. The interface energy obtained by the ab initio calculation is 1,656 ergs/cm² for Pd{111} plane, 2,131 ergs/cm² for Pd{100} plane and 2,167 ergs/cm² for Pd{110} plane.

For particles of 6 nm or more, too, Pd{111} plane having a coordination number of 9 is the widest. For particles having a diameter of 4 nm to 2 nm, however, the smaller the ratio of Pd{111} plane, the larger the ratio of Pd{110} plane. This is considered because, in order to minimize the surface area as much as possible, the shape of the palladium particles was changed from octahedron to closer to spherical. Moreover, for particles having a diameter of around 2 nm, the ratio of edge site shows a rapid increase. The ratio of Pd{110} plane is the largest in the case of a diameter of 2 nm. The ratio of Pd{100} plane is small in the cases of all diameters.

As a result of the simulation, the ratio of the crystal planes appearing on the surface of a palladium metal crystal produced by a conventional technique are, when the palladium crystal particle diameter is about 3 mm, Pd{111} plane, Pd{110} plane and Pd{100} plane are about 60%, about 30% and about 10%, respectively, based on the total surface area of the crystal of 100%. Among the crystal planes, Pd{111} plane is a crystal plane on which copper is likely to be deposited by the below-explained Cu-UPD method. Meanwhile, among the crystal planes, Pd{100} plane is a crystal plane on which copper is least likely to be deposited by the Cu-UPD method.

From the above consideration, in the core-shell type metal nanoparticles according to the present invention, the ratio of {100} plane of the core metal material, the plane appearing on the surface of the core portion, is preferably in the range of 0% or more and less than 10%, based on the total surface area of the core portion of 100%. The core-shell type metal nanoparticles having the core portion in which the ratio of {100} plane is 10% or more, are expected to have a low surface coverage of the core portion with the shell portion; therefore, there is a possibility that the core portion is eluted in the process of an electrochemical reaction.

The ratio of {100} plane of the core metal material, the plane appearing on the surface of the core portion, is particularly preferably in the range of 0 to 5%, most preferably 0%, based on the total surface area of the core portion of 100%.

From the point of view that it is possible to inhibit the elution of the core portion further, the surface coverage of the core portion with the shell portion is preferably from 0.9 to 1.

If the surface coverage of the core portion with the shell portion is less than 0.9, the core portion is eluted by an electrochemical reaction, so that there is a possibility that the core-shell type metal nanoparticles are deteriorated.

“Surface coverage of the core portion with the shell portion” means a ratio of the area of the core portion which is covered with the shell portion, with the premise that the total surface area of the core portion is 1. As the method for calculating the surface coverage, for example, there may be mentioned a method comprising the steps of observing several sites on the surface of the core-shell type metal nanoparticles by means of a TEM and calculating the ratio of the area of the core portion, which is confirmed by the observation to be covered with the shell portion, to the whole observed area.

Also, the surface coverage of the core portion with the shell portion can be a value obtained by dividing the adsorption or desorption charge amount of single atomic layer of copper atoms in the region of copper underpotential deposition potential, by a value obtained by doubling the adsorption or deposition charge amount of single atomic layer of proton atoms in the region of proton underpotential deposition potential, the copper atoms and proton atoms being in the core metal material and the absorption and desorption charge amounts being obtained by cyclic voltammetry.

Also, it is possible to calculate the surface coverage of the core portion with the shell portion by investigating components that are present on the outermost surface of the core-shell type metal nanoparticles by X-ray photoelectron spectroscopy (XPS) or time of flight secondary ion mass spectrometry (TOF-SIMS), etc.

As the core portion, there can be employed a core portion that comprises a metal crystal having a crystal system that is a cubic system and a lattice constant of a=3.60 to 4.08 Å. Examples of materials which can form such a metal crystal include metal materials such as palladium, copper, nickel, rhodium, silver, gold, iridium and alloys thereof. Among them, palladium is preferably used as the core metal material.

On the other hand, as the shell portion, there can be employed a shell portion that comprises a metal crystal having a crystal system that is a cubic system and a lattice constant of a=3.80 to 4.08 Å. Examples of materials which can form such a metal crystal include metal materials such as platinum, iridium, gold and alloys thereof. Among them, platinum is preferably contained in the shell portion.

By employing both the core metal material having the lattice constant and the shell portion containing the metal crystal having the lattice constant, no lattice mismatch occurs between the core and shell portions; therefore, a core-shell type metal nanoparticles can be obtained, which has a high surface coverage of the core portion with the shell portion.

In the core-shell type metal nanoparticles of the present invention, the shell portion covering the core portion is preferably a monatomic layer. Such particles are advantageous in that the catalytic performance of the shell portion is extremely higher and the material cost is lower because the covering amount of the shell portion is small, compared with a core-shell type catalyst having a shell portion comprising two or more atomic layers.

The core-shell type metal nanoparticles of the present invention preferably have an average particle diameter of 4 to 100 nm, more preferably 4 to 10 nm. Because the shell portion of the core-shell type metal nanoparticles is preferably a monatomic layer, the shell portion preferably has a thickness from 0.17 to 0.23 nm. Therefore, the thickness of the shell portion is negligible relative to the average particle diameter of the core-shell type metal nanoparticles, and it is preferable that the average particle diameter of the core portion is almost equal to that of the core-shell type metal nanoparticles.

The average particle diameter of the particles of the present invention is calculated by a conventional method. An example of a method for calculating the average particle diameter of the particles is as follows: first, for one particle shown in a transmission electron microscope (TEM) image taken at 400,000 or 1,000,000-fold magnification, the particle diameter is calculated on the supposition that the particle is spherical. This particle diameter calculation by TEM observation is performed on 200 to 300 particles of the same type and the average of these particles is deemed as the average particle diameter.

The core-shell type metal nanoparticles of the present invention can be supported by a carrier. Particularly in the case of using the core-shell type metal nanoparticles for a catalyst layer of a fuel cell, from the viewpoint of imparting electroconductivity to the catalyst layer, the carrier is preferably an electroconductive material.

Specific examples of the electroconductive material which can be used as the carrier include electroconductive carbon materials including carbon particles such as Ketjen Black (product name; manufactured by: Ketjen Black International Company), VULCAN (product name; manufactured by: Cabot Corporation), Norit (product name; manufactured by: Norit Nederland BV), BLACK PEARLS (product name; manufactured by: Cabot Corporation) and Acetylene Black (product name; manufactured by: Chevron Corporation) and carbon fibers.

### 2. Method for Producing Core-Shell Type Metal Nanoparticles

The method for producing core-shell type metal nanoparticles of the present invention is a method for producing core-shell type metal nanoparticles comprising a core portion comprising a core metal material and a shell portion covering the core portion, the method at least comprising the steps of: preparing fine core particles comprising the core metal material and substantially having no {100} plane of the core metal material on the surface thereof, and covering each of the fine core particles, which is the core portion, with the shell portion,

In the production method, the surface coverage of the core portion with the shell portion is increased by creating a core-shell structure comprising as the core portion fine core particles substantially having no {100} plane of the core metal material on the surface thereof, thereby producing core-shell type metal nanoparticles with excellent performance and durability.

The present invention comprises the steps of (1) preparing fine core particles and (2) covering the core portion with the shell portion. The present invention is not necessarily limited to the two steps only, and in addition to the two steps, the method can comprise a filtration/washing step, a drying step, a pulverization step, etc., which will be described below.

Hereinafter, the above steps (1) and (2), and other steps will be described in order.

### 2-1. Step of Preparing Fine Core Particles

The present invention is a step of preparing fine core particles comprising the core metal material and substantially having no {100} plane of the core metal material on the surface thereof. The state in which “substantially having no {100} plane of the core metal material” is the same as explained above.

As the method for producing fine core particles which selectively have crystal planes other than {100} plane of the core metal material on the surface thereof, conventionally known methods can be employed.

For example, a reference (Norimatsu et al., Shokubai, vol. 48 (2), 129 (2006)) and so on disclose a method for producing, when the fine core particles are fine palladium particles, fine palladium particles on which surface Pd{111} plane is selectively present.

As the method for determining whether or not the fine core particles substantially have no {100} plane of the core metal material on the surface thereof, for example, there may be mentioned a method for observing several sites on the surface of the fine core particles by TEM.

As the core particles, the metal crystals listed above under “1. Core-shell type metal nanoparticles” can be used. Examples of materials for forming the metal crystals are the same as the above listed metal materials.

The fine core particles can be supported by a carrier. Examples of the carrier are the same as those listed above under “1. Core-shell type metal nanoparticles”.

The average particle diameter of the fine core particles is not particularly limited as long as it is equal to or less than the average particle diameter of the above mentioned core-shell type metal nanoparticles.

However, when palladium particles are used as the fine core particles, the larger the average particle diameter of the palladium particles, the higher the ratio of the area of Pd{111} plane on the surface of each particle. This is because Pd{111} plane is the most chemically stable crystal plane among Pd{111}, Pd{110} and Pd{100} planes. Therefore, when palladium particles are used as the core particles, it is preferable that the palladium particles have an average particle diameter of 4 to 100 nm. From the point of view that the ratio of the surface area of one palladium particle to the cost per palladium particle is high, it is particularly preferable that the palladium particles have an average particle diameter of 4 to 10 nm.

### 2-2. Step of Covering Core Portion With Shell Portion

This is a step of covering each of the fine core particles, which is the core portion, with the shell portion.

The covering of the core portion with the shell portion can be performed through a one-step reaction or multiple-step reaction.

Hereinafter, there will be mainly described an example of the covering of the core portion with the shell portion through a two-step reaction.

As the step of covering the core portion with the shell portion through a two-step reaction, there may be mentioned an example that comprises at least the steps of covering each of fine core particles, which is the core portion, with a monatomic layer and replacing the monatomic layer with the shell portion.

A specific example of the above is a method comprising the steps of preliminarily forming a monatomic layer on the surface of the core portion by underpotential deposition and replacing the monatomic layer with the shell portion. As the underpotential, deposition, a method using copper underpotential deposition (hereinafter referred to as Cu-UPD) is preferably used.

Particularly when palladium particles are used as the fine core particles and platinum is used for the shell portion, core-shell type metal nanoparticles with a high platinum coverage and excellent durability can be produced by Cu-UPD. This is because, as described above, copper can be precipitated on Pd{111} plane and/or Pdf{110} plane by Cu-UPD at a surface coverage of 1.

Hereinafter, a specific example of Cu-UPD will be described.

First, palladium powder supported by an electroconductive carbon material (hereinafter referred to as Pd/C) is dispersed in water and filtered to obtain a Pd/C paste, and the paste is applied onto a working electrode of an electrochemical cell. For the working electrode, a platinum mesh or glassy carbon can be used.

Next, a copper solution is added to the electrochemical cell. In the copper solution, the working electrode, a reference electrode and a counter electrode are immersed, and a monatomic layer of copper is precipitated on the surface of the palladium particles by Cu-UPD. An example of the specific precipitation condition is as follows:
Copper solution: Mixed solution of 0.05 mol/L of CuSO₄ and 0.05 mol/L of H₂SO₄ (Nitrogen is bubbled thereinto)
Atmosphere: under a nitrogen atmosphere
Sweep rate: 0.2 to 0.01 mV/sec
Potential: After the potential is swept from 0.8 V (vs RHE) to 0.4 V (vs RHE), it is clamped at 0.4 V (vs RHE).
Voltage clamp time: 60 to 180 minutes

After the above voltage clamp time is passed, the working electrode is promptly immersed in a platinum solution to replace copper with platinum by displacement plating, utilizing the difference in ionization tendency. The displacement plating is preferably performed under an inert gas atmosphere such as a nitrogen atmosphere. The platinum solution is not particularly limited. For example, a platinum solution obtained by dissolving K₂PtCl₄ in 0.1 mol/L of HClO₄ can be used. The platinum solution is sufficiently agitated to bubble nitrogen therein. The length of the displacement plating time is preferably 90 minutes or more.

Core-shell type metal nanoparticles are obtained by the displacement plating, in which a monatomic layer of platinum is precipitated on the surface of the palladium particles.

As the material comprising the shell portion, the metal crystals listed above under “1. Core-shell type metal nanoparticles” can be used. Examples of the materials comprising the metal crystals are the same as the metal materials listed therein.

### 2-3. Other Steps

Before the step of preparing the fine core particles, the fine core particles can be supported by a carrier. As the method for supporting the core particles by a carrier, conventionally used methods can be employed.

After the step of covering the core portion with the shell portion, there may be performed filtration/washing, drying and pulverization of the core-shell type metal nanoparticles.

The filtration/washing of the core-shell type metal nanoparticles is not particularly limited as long as it is a method that can remove impurities without damage to the core-shell structure of the particles produced. An example of the filtration/washing is performing suction and filtration after adding ultra pure water. The operation of adding ultra pure water and then performing suction and filtration is preferably repeated about 10 times.

The drying of the core-shell type metal nanoparticles is not particularly limited as long as it is a method that can remove a solvent, etc. An example of the drying is drying for about 12 hours with a vacuum drier in the condition of a temperature of about 60° C.

The pulverizing of the core-shell type metal nanoparticles is not particularly limited as long as it is a method that can pulverize solid contents. Examples of the pulverization include pulverization using a mortar, etc., and mechanical milling using a ball mill, a turbo mill, mechanofusion, a disk mill, etc.

### EXAMPLES

### 1. Production of Palladium-Supported Carbon

### Example

A palladium-supported carbon having an average particle diameter of 3.8 nm was used. According to the above-described simulation, the ratio of Pd{100} plane on the surface of palladium in the palladium-supported carbon is about 3%.

The method for producing the palladium-supported carbon follows a conventional method explained below. First, a carbon powder was suspended in water and a palladium solution was added thereto. Next, the mixture was heated to sorb palladium, followed by filtration/washing. The washed palladium carbon was dried and then subjected to thermal reduction, thereby producing the palladium-supported carbon.

### Comparative Example

A palladium-supported carbon having an average particle diameter of 6.3 nm was used. According to the above-described simulation, the ratio of Pd{100} plane on the surface of palladium in the palladium-supported carbon is about 7%.

The method for producing the palladium-supported carbon is the same as the method described above under “Example”.

### 2. Measurement of Surface Coverage of Palladium With Copper

The surface coverage of palladium with copper was measured by cyclic voltammetry, using the palladium-supported carbons of Example and Comparative Example. A rotating disk electrode having an electrode area of 0.196 cm² was used as the measurement device.

First, the surface of a glassy carbon (GC) electrode was polished to mirror finish by buffing. Next, the electrode was subjected to ultrasonic cleaning with ultrapure water. Then, the palladium-supported carbon of Example or Comparative Example of 10 to 30 mL, ultrapure water of 6 mL, isopropyl alcohol of 1.5 mL and 5% Nafion (product name: Nafion perfluorinated ion-exchange resin 527054; manufactured by: ALDRICH Corporation) of 30 μL were mixed to prepare an ink. After the ink was subjected to ultrasonic dispersion, about 10 μL of the ink was applied to the electrode. At this stage, the amount of the palladium-supported carbon applied to the electrode was about 40 μg.

Then, the adsorption charge amount of single atomic layer of proton atoms in the region of proton underpotential deposition potential, was measured. 0.1 mol/L HClO₄ was poured into a glass cell. The above-mentioned electrode was attached to the glass cell. While bubbling argon gas into the perchloric acid aqueous solution in the glass cell, the potential was swept in a potential sweep range of 0.05 to 1.085 V (vs RHE) and a potential sweep rate of 50 mV/sec to measure a kinetic current that flowed. The absorption charge amount was calculated from the current that flowed when the potential was decreased from 1.085 V to 0.05 V, and electric double layer capacitance was deducted therefrom. To exclude the current which is derived from hydrogen absorption of palladium and which flows at a lower potential than around 0.09 V, a current value just before a hydrogen absorption-derived increase in current value, was used in the calculation.

Next, the adsorption charge amount of single atomic layer of copper atoms in the region of copper underpotential deposition potential, was measured. mixed solution of 0.05 mol/L CuSO₄ and 0.05 mol/L H₂SO₄ was poured into a glass cell. The above-mentioned electrode was attached to the glass cell. While bubbling nitrogen into the copper aqueous solution in the glass cell, the potential was swept in a potential sweep range of 0.35 to 0.8 V (vs RHE) and at a potential sweep rate of 5 mV/sec to measure a kinetic current that flowed. The adsorption charge amount was calculated from the current that flowed when the potential was decreased from 0.7 V to 0.4 V, and electric double layer capacitance was deducted therefrom.

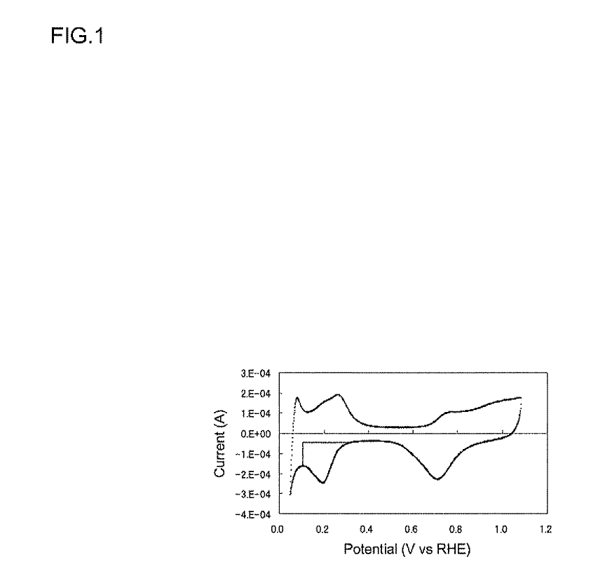

The calculation method and results of the surface coverage of palladium with copper, will be explained hereinafter, using FIGS. 1 to 4. The adsorption charge amount can be obtained by integrating the current value of a predetermined area in a voltammogram with time.

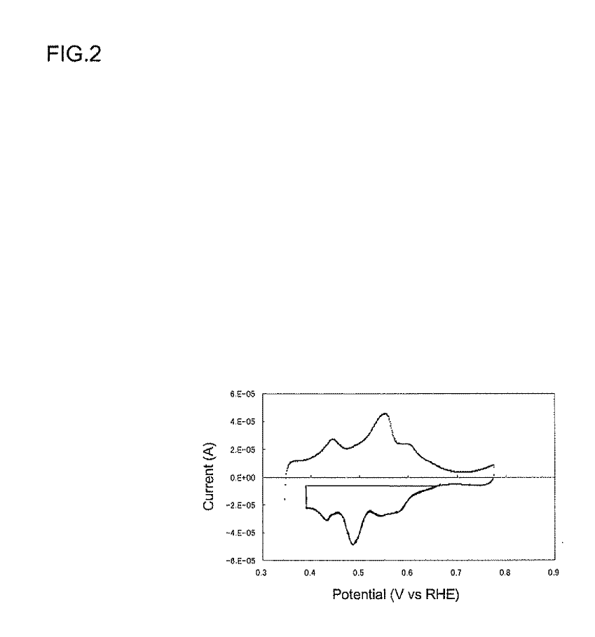

First, the surface coverage of the palladium of Example with copper was calculated. FIG. 1 shows a voltammogram of the palladium-supported carbon of Example in the perchloric acid aqueous solution. The proton adsorption charge amount of the palladium was calculated from the proton adsorption peak area indicated by diagonal lines in FIG. 1; therefore, it was 5.41×10⁻⁴ C (coulomb). FIG. 2 shows a voltammogram of the palladium-supported carbon of Example in the CuSO₄/H₂SO₄ mixed aqueous solution. The copper adsorption charge amount of the palladium was calculated from the copper adsorption peak area indicated by diagonal lines in FIG. 2; therefore, it was 1.06×10⁻³ C. Therefore, the value obtained by dividing the copper adsorption charge amount by the value obtained by doubling the proton adsorption charge amount, that is, the surface coverage of palladium with copper, was 0.98.

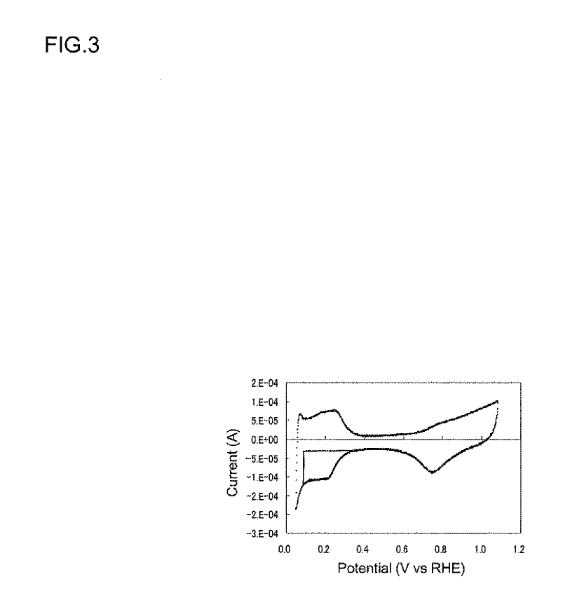

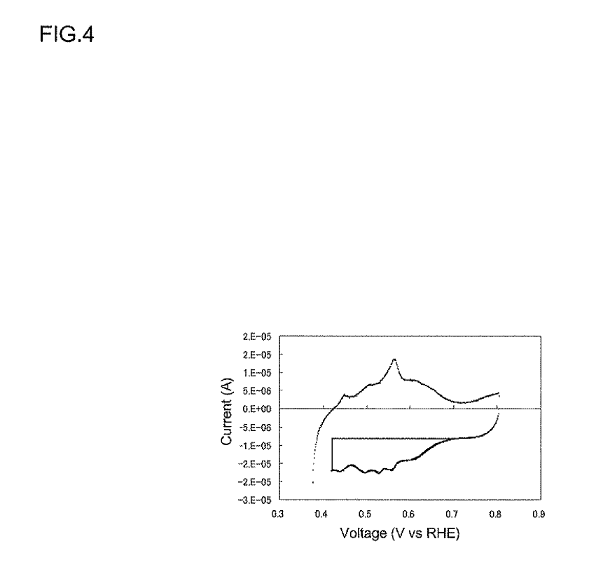

The surface coverage of the palladium of Comparative Example with copper was calculated in the same manner. FIG. 3 shows a voltammogram of the palladium-supported carbon of Comparative Example in the perchloric acid aqueous solution. The proton adsorption charge amount of the palladium was calculated from the proton adsorption peak area indicated by diagonal lines in FIG. 3; therefore, it was 2.99×10⁻⁴ C. FIG. 4 shows a voltammogram of the palladium-supported carbon of Comparative Example in the CuSO₄/H₂SO₄ mixed aqueous solution. The copper adsorption charge amount of the palladium was calculated from the copper adsorption peak area indicated by diagonal lines in FIG. 4; therefore, it was 3.74×10⁻⁴ C. Therefore, the value obtained by dividing the copper adsorption charge amount by the value obtained by doubling the proton adsorption charge amount, that is, the surface coverage of palladium with copper, was 0.63.

It is clear from these results that in the case of using a palladium-supported carbon comprising fine palladium particles substantially having no Pd{100} plane on the surface thereof, the surface coverage of palladium with copper is increased about 1.6 times higher than conventional palladium-supported carbons. This fact means that the surface coverage of palladium with platinum is increased about 1.6 times by replacing single atomic layer of copper with platinum by Cu-UPD, etc.

Therefore, it is clear that core-shell type metal nanoparticles having a higher surface coverage of the core with the shell than those produced by conventional core-shell type fine particles production methods, can be obtained by the production method of the present invention.

### REFERENCE SIGNS LIST

1. Pd{111} plane
2. Pd{100} plane
3. Pd{110} plane
100. Truncated octahedron
L. Length of a side of the octahedron
s. Length of a side of a truncated part

1. Core-shell type metal nanoparticles comprising a core portion comprising a core metal material and a shell portion covering the core portion,
wherein the ratio of {100} plane of the core metal material appearing on the surface of the core portion, is in the range of 0 to 5%, based on the total surface area of the core portion of 100%, the ratio being estimated by a predetermined simulation method.

2. The core-shell type metal nanoparticles according to claim 1, wherein the core portion comprises a metal crystal having a crystal system that is a cubic system and a lattice constant of a=3.60 to 4.08 Å.

3. The core-shell type metal nanoparticles according to claim 1, wherein the shell portion comprises a metal crystal having a crystal system that is a cubic system and a lattice constant of a=3.80 to 4.08 Å.

4. The core-shell type metal nanoparticles according to claim 1, wherein a surface coverage of the core portion with the shell portion is 0.9 to 1.

5. The core-shell type metal nanoparticles according to claim 1, wherein the core metal material is a metal material selected from the group consisting of palladium, copper, nickel, rhodium, silver, gold, iridium and alloys thereof.

6. The core-shell type metal nanoparticles according to claim 1, wherein the shell portion comprises a metal material selected from the group consisting of platinum, iridium, gold and alloys thereof.

7. The core-shell type metal nanoparticles according to claim 1, being supported by a carrier.

8. A method for producing core-shell type metal nanoparticles comprising a core portion comprising a core metal material and a shell portion covering the core portion,
the method at least comprising the steps of:
preparing fine core particles comprising the core metal material and having a ratio of {100} plane of the core metal material appearing on the surface of the core portion of in the range of 0 to 5%, based on the total surface area of the core portion of 100%, the ratio being estimated by a predetermined simulation method, and
covering each of the fine core particles, which is the core portion, with the shell portion.

9. The method for producing core-shell type metal nanoparticles according to claim 8,
wherein the core portion covering step with the shell portion comprises at least the steps of:
covering each of the fine core particles, which is the core portion, with a monatomic layer, and
replacing the monatomic layer with the shell portion.

10. The method for producing core-shell type metal nanoparticles according to claim 8, wherein a metal crystal having a crystal system that is a cubic system and a lattice constant of a=3.60 to 4.08 Å, is used as the fine core particles.

11. The method for producing core-shell type metal nanoparticles according to claim 8, wherein a metal crystal having a crystal system that is a cubic system and a lattice constant of a=3.80 to 4.08 Å is used in the shell portion.

12. The method for producing core-shell type metal nanoparticles according to claim 8, wherein the core metal material is a metal material selected from the group consisting of palladium, copper, nickel, rhodium, silver, gold, iridium and alloys thereof.

13. The method for producing core-shell type metal nanoparticles according to claim 8, wherein the shell portion comprises a metal material selected from the group consisting of platinum, iridium, gold and alloys thereof.

14. The method for producing core-shell type metal nanoparticles according to claim 8, wherein the fine core particles are supported by a carrier.

15. (canceled)

16. The method for producing core-shell type metal nanoparticles according to claim 8, wherein the predetermined simulation method comprises the steps of:
determining a truncated octahedron structure having a ratio (s/L) of a side of a truncated part, s, to a side of an octahedron, L, of 0.2 as the initial structure of the fine core particles;
determining a stable structure of the initial structure by the Monte Carlo simulation, using an algorithm of the Metropolis method as the determination method; and
calculating the ratio of the {100} plane appearing on the surface of each of the fine core particles, based on the total surface area of each of the core portion of 100%, by analyzing the stable structure by the modified embedded atom method.

17. The core-shell type metal nanoparticles according to claim 1, wherein the predetermined simulation method comprises the steps of:
determining a truncated octahedron structure having a ratio (s/L) of a side of a truncated part, s, to a side of an octahedron, L, of 0.2 as the initial structure of the core portion;
determining a stable structure of the initial structure by the Monte Carlo simulation, using an algorithm of the Metropolis method as the determination method; and
calculating the ratio of the {100} plane appearing on the surface of the core portion, based on the total surface area of the core portion of 100%, by analyzing the stable structure by the modified embedded atom method.
